(19) United States
(12) Patent Application Publication
(10) Pub. No.: US 2003/0005432 A1
(43) Pub. Date: Jan. 2, 2003

(54) Interactive television application with research features

(76) Inventors: Michael D. Ellis, Boulder, CO (US); Jonathan Peter Vincent Drazin, Burnham (GB)

Correspondence Address: FISH & NEAVE, 1251 AVENUE OF THE AMERICAS, 50TH FLOOR, NEW YORK, NY, 10020-1105, US

(21) Appl. No.: 09/996,052

(22) Filed: Nov. 28, 2001

Related U.S. Application Data
(60) Provisional application No. 60/253,594, filed on Nov. 28, 2000.

(51) Int. Cl. G06F 13/00; H04H 9/00

(52) U.S. Cl. 725/13; 725/39

(57) ABSTRACT

Systems and Methods for an interactive television application are implemented to have data collection features. Data may be collected on acts that occur to interface a user and the interactive television application that has been implemented on user equipment. The acts may be discrete acts such as user key entries on a remote control, displays that are generated by the interactive television application, channels changes, etc. Duration information may be recorded. A data record may be generated for each discrete act. Data records may be in a format that is compatible with conventional database applications.

### CROSS REFERENCE TO RELATED APPLICATION

This application claims the benefit of U.S. Provisional Patent Application No. 60/253,594 filed Nov. 28, 2000, which is hereby incorporated by reference herein in its entirety.

### BACKGROUND OF THE INVENTION

This invention relates to interactive television program guide systems and, more particularly, to interactive television program guide systems that support research activities.

Interactive television program guide systems have been developed to aid users in conducting television related activity. For example, an interactive television program guide system may be used to change channels, to set reminders, to record programs, etc. Illustrative interactive television program guides are described, for example, in Knee et al. U.S. Pat. No. 5,589,892, Knudson et al. U.S. patent application Ser. No. 09/070,555, filed Apr. 30, 1998, and Knudson et al. U.S. patent application Ser. No. 09/357,941, filed Jul. 16, 1999, which are hereby incorporated by reference herein in their entireties. Illustrative client-server program guide systems are described, for example, in Ellis et al. U.S. patent application Ser. No. 09/374,043, filed Aug. 13, 1999, which is hereby incorporated by reference herein in its entirety. Program guides may be on-line program guides, which may be implemented using a web server on the Internet. Illustrative on-line program guide systems are described, for example, in Boyer et al. U.S. patent application Ser. No. 08/938,028, filed Sep. 18, 1997, which is hereby incorporated by reference herein in its entirety.

Interactive program guides or other interactive television applications may allow users to record programs on digital or analog storage devices (e.g., videocassettes, hard disks, floppy discs, flash memory, recordable compact discs, recordable digital versatile discs, or any other type of storage). Illustrative interactive program guides having digital storage are described, for example, in Hassel et al. U.S. patent application Ser. No. 09/157,256, filed Sep. 17, 1998, which is hereby incorporated by reference herein in its entirety. Recording of media can also be performed by a program guide or other server. Examples of program guides that have remote server recording features are illustratively shown in U.S. patent application Ser. No. 09/332,244, which is hereby incorporated herein in its entirety.

While it is useful to facilitate user interaction with the program guide, it may also be desirable to know what particular interactions occur between a user and a guide.

Information on program guide and user activity may be of great value to researchers and advertisers. Using such information, researchers may ascertain desired information for a wide range of research purposes.

### SUMMARY OF THE INVENTION

In accordance with the principles of the present invention an interactive television application may be provided for researching interactive television application and/or user activity and storing information related to the application and/or user activity.

A data collection device may be implemented at user equipment for collecting and/or generating data. An interactive television application may have been implemented using user equipment that may interface with user through a user input device, through displays that are presented to the user, through the activity in the displays that are presented to the user, through selections that the user makes, through key entries on the user input device, etc. Data may be generated and/or collected by the data collection device for actions (e.g., discrete acts) occurring between the user and the application to interface the user and the application. Different classes of data may be generated. For example, one class of data may be data that is valuable to advertisers in determining where to present advertisements to a particular user and the pricing for advertisements. Another class may be data that is valuable to researchers to recreate how a user has interacted with an application to identify the effectiveness of the features implemented in the application. Another class may be data that is valuable for identifying a profile for a user. Other classes of data may also exist.

Data may be generated for a wide range of actions, which are further discussed below. Data collected by a data collection device may be stored locally and/or transmitted to a central facility. Generated data may be screened to filter out some of the data. Research processes or algorithms may be applied to the data of the data collection device to produce resultant information. Confidentiality features may be provided. An interactive television application system that includes research features may log events to track television, application, and user activity. The information that is logged may be used to support research studies. Data that is generated may be data for identifying acts that are manually taken by a user (e.g., user key entries) and for automatic acts that are driven by the interactive television application (e.g., the application displays a reminder).

Data may be collected in substantially raw form to be flexible for use in a wide range of studies. A software version for an interactive television application may be sent to the central facility. The software version may aid in interpreting the collected data, collected from a number of different user equipment.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, in which:

FIG. 1 is a schematic block diagram of an illustrative system in accordance with the present invention.

FIG. 2 is an illustrative schematic block diagram of a first embodiment of user equipment of FIG. 1 in accordance with of the present invention.

FIG. 3 is an illustrative schematic block diagram of a second embodiment of user equipment of FIG. 1 in accordance with the present invention.

FIG. 4 is an illustrative schematic block diagram of a third embodiment of user equipment of FIG. 1 in accordance with the present invention.

FIG. 5 is a flow chart of illustrative steps involved in providing data collection related features in accordance with the present invention.

FIG. 6 is a flow chart of illustrative steps involved in selectively enabling data collection features in accordance with the present invention.

FIG. 7 is a flow chart of illustrative steps involved in implementing data collection in accordance with the present invention.

FIG. 8 is a flow chart of illustrative steps involved in storing research-related data in accordance with the present invention.

FIG. 9 is an illustration of interface classes for which data may be generated in accordance with the present invention.

FIGS. 10-16 are diagrams of illustrative display screens that may be implemented for which data collection may be provided in accordance with the present invention.

### DETAILED DESCRIPTION

An interactive television system may be based on a number of different hardware platforms. Some of such hardware platforms are illustratively described herein. Suitable hardware that may be used in implementing interactive television services includes hardware such as satellite receivers, personal computer televisions (PC/TVS), personal computers (e.g., with television tuner cards), cable set-top boxes, television sets, video recorders, or any other suitable hardware. Data for interactive television services may be provided on a television channel sideband, using an out-of-band digital data stream, in the vertical blanking interval, using an in-band digital data stream, using a telephone or cable modem, as one or more data stream components that are multiplexed with digital television audio and video service and system information components to form a broadcast data transport stream (such as described by, but not limited to, the MPEG-2, OpenCable, and DVB MHP standards specifications), or by any other suitable data transmission technique.

An interactive television application may be implemented in a television system to provide desired interactive television functionality. A research application may be implemented to provide research-related functionality. If desired, the research application may have been implemented as part of the interactive television application or may be implemented separate from the interactive television application. The research application may be invisible to the interactive television application and/or invisible to the users of the interactive television application.

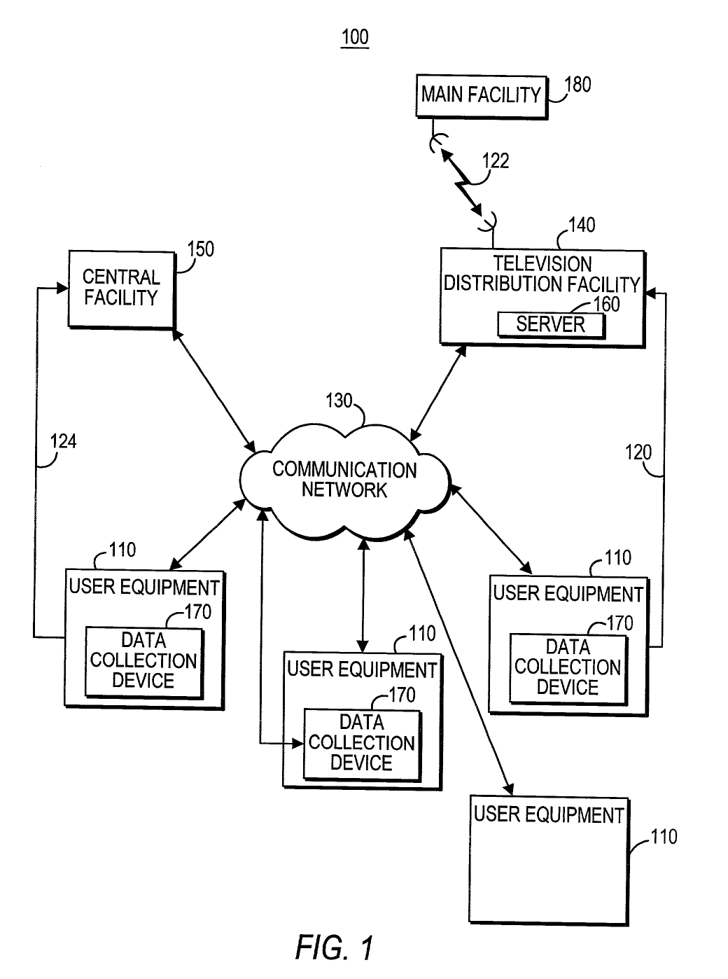

An illustrative system 100 is shown in FIG. 1. For clarity and brevity, the interactive television system and research features that are discussed herein are primarily discussed in the context of program guides. Other interactive television applications may also be included. Such interactive television applications may include web browsers, electronic mail applications, shopping applications, games, news and information applications, etc. Program guide information may be distributed from one or more main facilities 180 to television distribution facility 140 or other distribution facility and ultimately to user equipment 110. Main facility 180 may include a program guide database for storing program guide information (e.g., channel listings information, channel-related information, network listings information, pay-per view ordering information, etc.). Main facility 180 may transmit information from the program guide database to television distribution facility 140 through communication link 122.

Television distribution facility 140 may include program guide server 160 which may receive data from or transmit data to user equipment 110 via communications link 120 and/or communications network 130. If desired, program guide server 160 may be located at a location other than television distribution facility 140. Data collection device 170 may be provided as part of user equipment 110. For clarity and brevity, data collection device 170 is discussed to be part of user equipment 110. However, in some embodiments, data collection device 170 may be considered to be equipment separate from user equipment 110.

Server 160 may be a server for supporting program guide operations, may be a server for supporting research features, or may be a combination thereof. If desired, server 160 may include one server for research activity and another server for program guide activity.

Server 160 may use any suitable combination of hardware and software to provide client-server-based communications between server 160 and user equipment 110.

Data collection device 170 may be implemented or enabled in a subset of homes that have program guides. Data collection devices 170 may send research data to television distribution facility via a communications link such as communications link 120 or communication network 130. If desired, central facility 150 may be part of television distribution facility 140 or central facility 150 and television distribution facility 140 may communicate using communication network 130 or other communications link.

If desired, user equipment 110 may communicate directly with central facility 150 via communications link 124. If desired, data collection device 170 may communicate with central facility 150 via communication network 130.

Communication network 130 may include a communications network that may use any suitable network and transport layer protocol, for example, a protocol stack which includes Sequenced Packet Exchange/Internetwork Packet Exchange (SPX/IPX) layers or Transmission Control Protocol/Internet Protocol (TCP/IP) layers. Communication network 130 may include a wide area network such as the Internet.

Communication link 122 may be a satellite link, a telephone network link, a cable or fiber optic link, a microwave link, an internet link, a combination of such links, or any other suitable communications link. Video signals may also be transmitted over link 122 and/or network 130 if desired. A number of different communications links are illustratively described in connection with FIG. 1 to demonstrate different communications arrangements that may be implemented. Television distribution facility 140 may be a cable headend or some other television distribution source.

Main facility 180 may be back office equipment that is used to distribute data such as television programming information to a number of different television distribution facilities 140. If desired, communications between main facility 180 and television distribution facilities 140 may carry data and other subject matter (e.g., instructions for interactive television applications). Central facility 150 may be a data collection site that may collect research data that is generated, processed, or screened at user equipment 110. Central facility 150 may receive data from user equipment 110 and may analyze the data to obtain useful information. Data collected by central facility 150 may be based on interactions that occur at user equipment 110 using data and or other subject matter that is distributed by main facility 180.

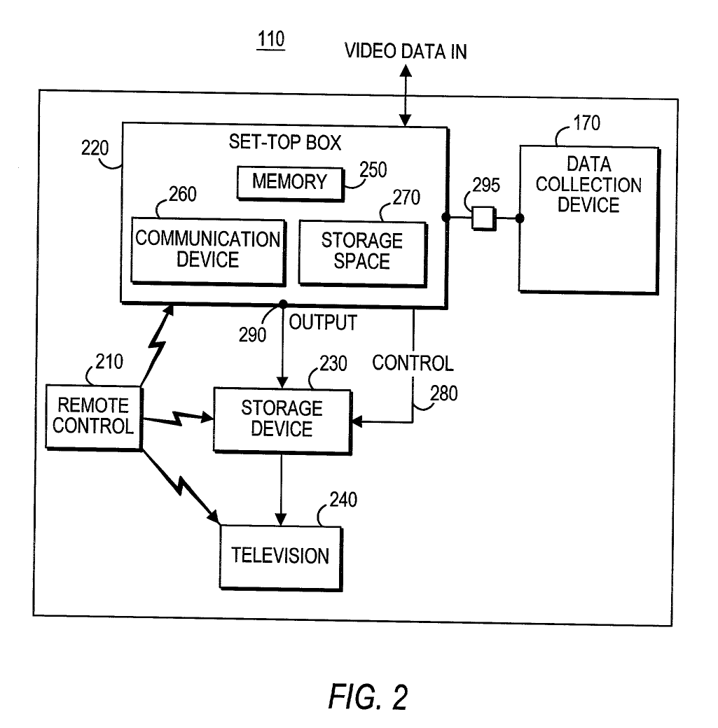

As shown in FIG. 2, user equipment 110 may include set-top box 220 on which a program guide application may be partly implemented, and may include data collection device 170, television 240, and remote control 210. For convenience, user equipment 110 is primarily discussed herein in the context of a user input interface that is a remote control (e.g., remote control 210). User equipment 110 receives video or a digital video stream and data from television distribution facility 140 of FIG. 1 or from server 160 at television distribution facility 140 of FIG. 1.

A viewer may tune set-top box 220 to a desired television channel. The signal for that television channel may be provided at output 290 for use by equipment such as storage device 230 and television 240. The signal may be in a format that is compatible for use by equipment downstream. An interactive television application such as a program guide application may be implemented on set-top box 220, on television 240 (if it has suitable processing circuitry and memory), on storage device 230 (if it has suitable processing circuitry and memory) or on combinations thereof.

Storage device 230 can be any suitable type of analog or digital program storage device or player (e.g., a videocassette recorder (VCR), a personal video recorder (PVR), a digital versatile disc (DVD) player, etc.). Program recording and other features may be controlled by set-top box 220 using control path 280. Control path 280 may involve the use of an infrared transmitter coupled to an infrared receiver of storage device 230 that is normally used to accept commands from remote control 210. Remote control 210 may be used to control set-top box 220, storage device 230, and television 240.

If desired, set-top box 220 may include storage device 270. Storage device 270 may be used to record programs, record data (e.g., interactive television data, research data, etc.), or record a combination thereof in digital form. Storage device 270 may be a writeable optical storage device (such as a DVD player capable of handling recordable DVD discs), a magnetic storage device (such as a disc drive), or any other digital storage device.

Television 240 may receive video signals from storage device 230 for presentation to users. The video signals may be signals generated by storage device 230, signals from storage device 270, signals tuned by set-top box 220, or signals directly received by television 240 (e.g., received through an antenna).

Set-top box 220 may include memory 250. Memory 250 may be practically any type of memory or storage, such as random access memory (RAM), read-only memory (ROM), a hard disc drive, a combination of such devices, etc., that is suitable for storing instructions for applications and for storing data. Set-top box 220 may include communications device 260 for communicating with television distribution facility 140 of FIG. 1 (e.g., communicating with server 160 of FIG. 1). Communications device 260 may be a modem (e.g., any suitable digital or analog standard, cellular, or cable modem), a network interface card (e.g., an Ethernet card, Token ring card, etc.), or other suitable communications device.

User equipment 110 may include data collection device 170. Data collection device 170 may communicate with set-top box 220 via conversion device 295.

A data collection device such as data collection device 170 may communicate with a central facility (e.g., central facility 150 of FIG. 1) through set-top box 220 or through some other communication capable device such as an internal modem.

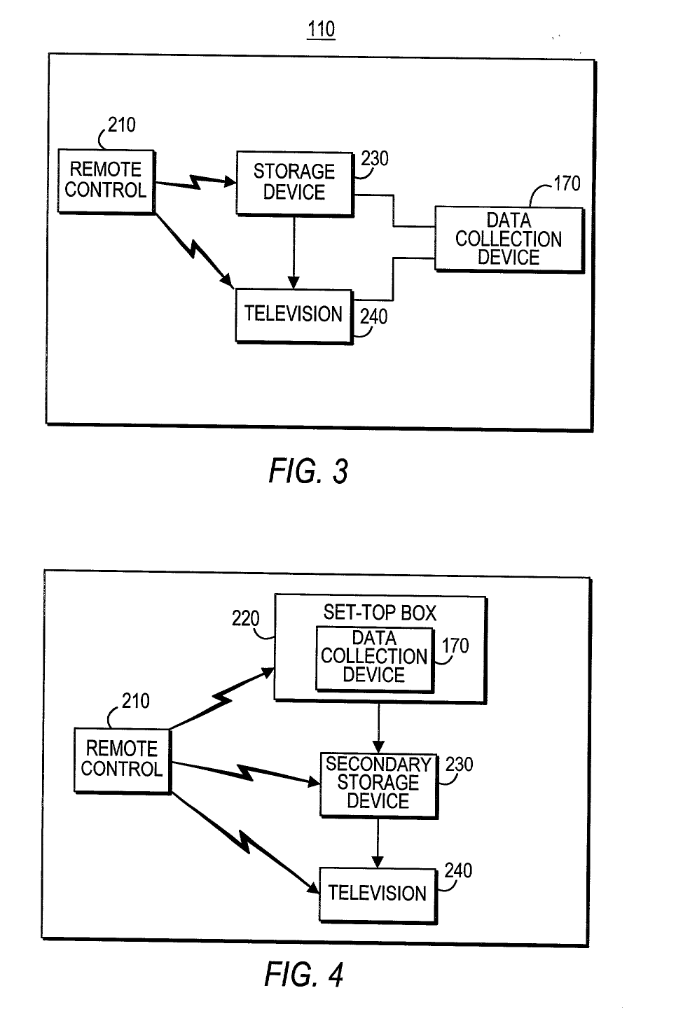

FIGS. 2, 3, and 4 illustratively show different possible arrangements for user equipment 110. Other arrangements may also be used. As shown in FIG. 3, data collection device 170 may be coupled to storage device 230 and/or television 240 when an interactive television application has been implemented on storage device 230 and/or television 240. As shown in FIG. 4, data collection device 170 may be part of set-top box 220 (if set-top box 220 has suitable processing circuitry and memory).

Various techniques may be used to establish communications between data collection device 170 and an interactive television application implemented on user equipment 110. For example, with reference again now to FIG. 2, conversion device 295 may be used to convert signals between set-top box 220 and data collection 170. Set-top box 220 may have a communications port such as an infrared communications port (e.g., an IR blaster port) for controlling storage device 230. Data collection device 170 may have a communications port for communicating with other user equipment. The communications port of data collection device 170 may be a port that is for electrical signal communications. The communications port of set-top box 220 may be directed towards conversion device 295, which may be coupled to the communications port of data collection device 170. Conversion device 295 may perform a signal type conversion (e.g., infrared to electrical conversion), a data format conversion, signal level conversion, and other signal modifications.

Data collection device 170 may share processing communications, and/or storage resources with other equipment in user equipment 110 or may have separate (e.g., dedicated) processing, communications and/or storage resources. Combinations of shared and separate resources may also be used.

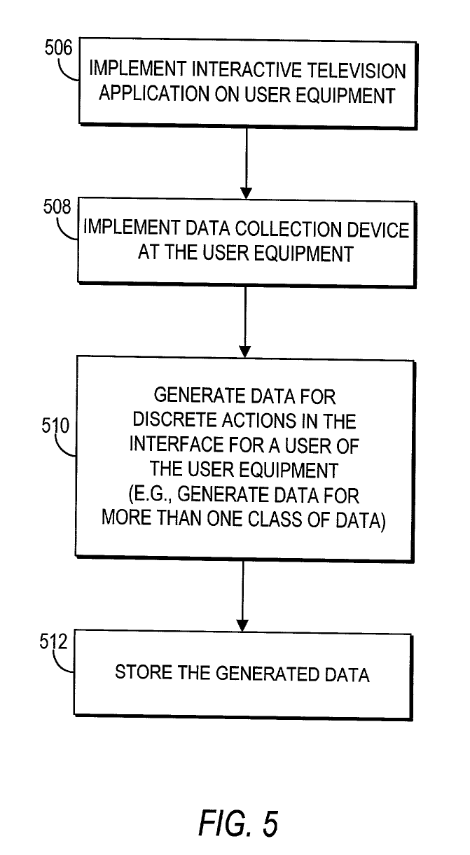

Illustrative steps involved in providing data collection are shown in FIG. 5. With reference now to FIG. 5, at step 506, an interactive television application may be implemented using user equipment to aid a user in managing resources (e.g., television channels) that are available through the user equipment. The resources may be made available to the user through the interactive television application or in cooperation with the interactive television application. The interactive television application may present information, audiovisuals, advertisements, display screens, overlays, options for different application features, etc. to a user. As mentioned above, a user input device may be used to interact with the interactive television application. Information, audiovisuals, advertisements, display screens, overlays, options, etc. that are presented to a user form part of an application interface. The application interface may further include user input device entries made by that user. At step 508, a data collection device may be implemented at the user equipment to collect data on activity at the interface. At step 510, data may be generated for discrete actions that occur at the application interface of that user. Data may be generated for more than one class of interaction. For example data may be generated for user selections made through the application and generated user interactions at the application interface (e.g., actions taken to make a selection). Different classes of information may be differentiated or identified based on the focus for which the information is collected. For example, one class of information may be information that is collected to identify parameters for a user profile. Another class of information may be collected having another focus (e.g., system usability). Another example may involve differentiating between information that is collected to identify where to place advertisements (e.g., how to target advertisements to a particular user, what prices should be charged for different advertisement locations, etc.) and information that is collected for another focus.

At step 512, the data that has been generated may be stored. The data may be stored in digital storage of the data collection device, in a set-top box, television, in a video storage device, in a television distribution facility, or in combinations thereof.

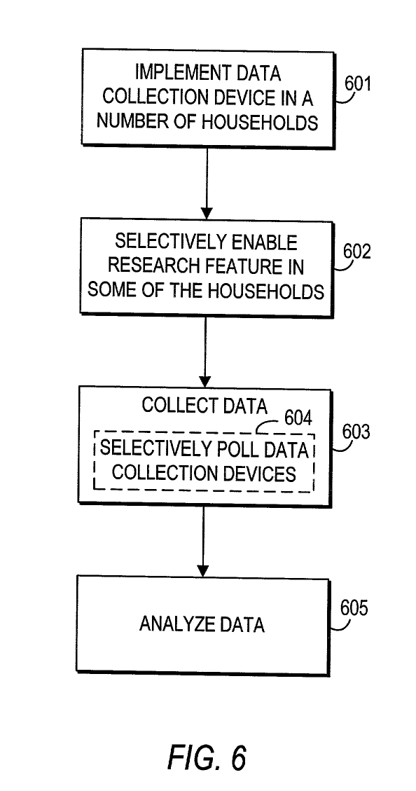

FIG. 6 is a flow chart of illustrative steps involved in selectively collecting data from different households. At step 601, a data collection device may be implemented in a number of households (e.g., implemented for substantially all user equipment that is deployed or for a statistically significant subset of the user equipment that is deployed). At step 602, data collection may be selectively enabled for a subset of the households in which the data collection device was implemented. If desired, a data collection device may be selectively enabled when the data collection device has been implemented and has established appropriate communications with an interactive television application from which the device will be receiving data. At step 603, data may be collected based on actions occurring at the user-application level. Data may be collected/generated using the enabled data collection devices.

Depending on the communications arrangement that is used, data may be collected or stored in a number of different ways. For example, data may be collected and stored locally and later sent to a central facility. Another example may involve collecting the data locally and passing the data to a central facility without locally storing the data in nonvolatile memory. The data collection device may be in communications with an interactive television application and/or a central facility using a handshaking technique, using two-way communications techniques, using one way communications techniques, using periodic communications techniques, using on-demand communications techniques, using other communications techniques, or combinations of these techniques as appropriate.

If desired, a polling type communications technique may be used for sending data to a central facility. A central facility may broadcast (e.g., broadcast through a television distribution facility) messages that poll particular data collection devices for data at step 604. Polling step 604 may be a substep of step 603. Polling messages may identify which data collection devices are to provide data to the central facility. The polling messages may also be used to configure when and how the data collection device is to send the data. For example, a polling message may set the schedule for when to send data and may specify a telephone number that is to be used to establish a communications connection for sending the data. At step 605, the data may be analyzed. For example, the data may be analyzed to recreate activity that has occurred between a user and an application.

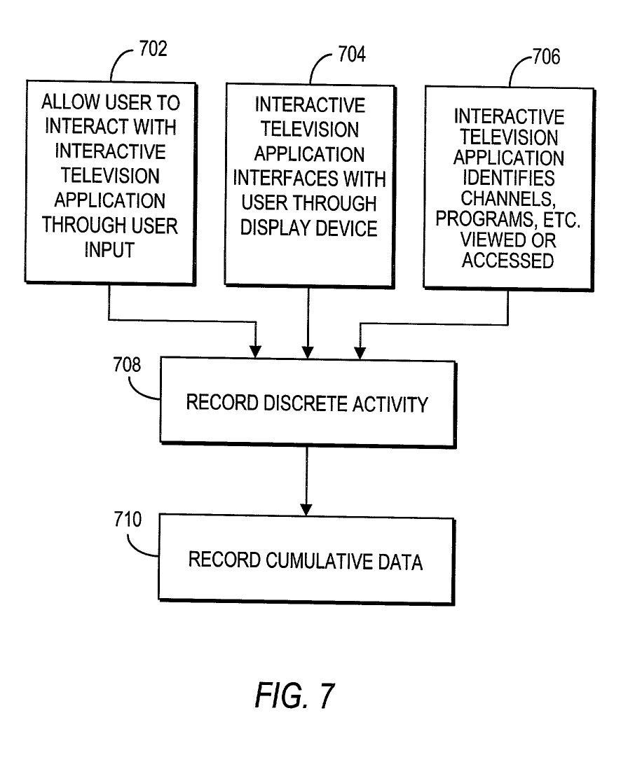

Data collection may be provided to obtain individual histories of activities and to provide cumulative activity data. For example, with reference now to FIG. 7, interface parameters may be established using steps 702, 704, and 706. At step 702, a user may be allowed to interact with an interactive television application through a user input device (e.g., a remote control). At step 704, the interactive television application may interface with the user through application-generated graphics (e.g., display screens) that are presented to the user on a display device. At step 706, the interactive television application may identify channels, programs, etc. that are viewed or accessed by the user.

At step 708, data identifying discrete activity occurring in steps 702, 704, and/or 706 may be recorded. Duration information for the activity (e.g., each activity) may also be recorded. An individual data record may be generated for each activity that is representative of that activity. At step 710, cumulative data may be recorded on the discrete activity. The cumulative data may be for a particular period of time and may be representative of the rate of repetition or usage of discrete events over a particular period of time.

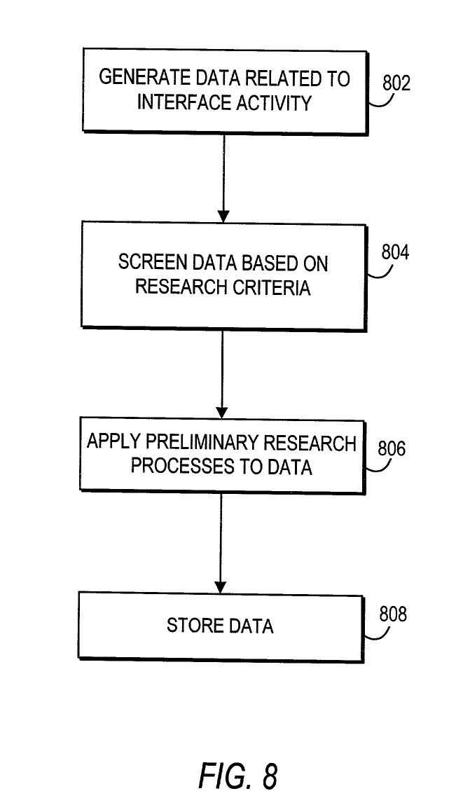

FIG. 8 is a flow chart showing illustrative steps involved in storing research data. At step 802, data (e.g., a data record) may be generated that is related to interface activity. Data may be representative of discrete acts that have occurred in an application interface. Data may be generated for each discrete act at the application interface. If desired, data may be generated for a subset of discrete acts that can occur in an application interface. (e.g., one data item may represent an aggregation of multiple actions, one data item may represent a statistical subset of multiple actions, or data items may be logged for only selected actions). Thus, the data may be an activity log for an interactive television application, or may be an activity log for particular functionality in the interactive television application (e.g., parental control, cursor movement, user input, etc.). Data may be collected for a number of different purposes or may be collected in mass before the research purposes for which the data is to be used have been identified. Research purposes may include purposes such as research related to quality of service, usability, demographics, trends, or gathering of television channel viewing statistics or measurement/verification of television, program guide or interactive television application advertising impression levels (e.g., different graphics that have different levels of detail of information for an advertisement), etc. If desired, at step 804, data that has been generated may be screened to filter out some data based on current research criteria. For example, activity that is of lesser research value may be disregarded. At step 806, the screened data may be processed by applying preliminary research techniques to reduce the volume of the data. For example, a particular research algorithm or process may be implemented as part of the data collection device to extract demographic information from activity on which data was collected. The information may be extracted based on criteria such as the time at which programming was watched, for how long programming was watched, the viewing frequency of the channels or programs that were watched, actions that occurred in connection with parental control features, actions that occurred in connection with paid services, actions that occurred at a prior time, demographic information that has been separately collected, etc. At step 808, the data may be stored at the user equipment and/or transmitted to the central facility for storage and/or analysis. Data may be transmitted frequently to the central facility to save on a storage device at the collection device. Data compression techniques may also be used.

If desired, steps 802 and/or 808 may be implemented without performing steps 804 and/or 806. Also if desired, steps 804 and/or 806 may be performed entirely at the user equipment or distributed over different sites (e.g., performed at user equipment and a central facility). Steps 804 and/or 806 may be used to reduce the volume or amount of data that is generated and/or stored at user equipment. For example aggregation processing techniques may be applied to reduce the amount of data. Some data may be aggregated, for example, to obtain cumulative information. Processing may be performed shortly or immediately after relevant data is generated. This may allow the system to store (e.g. only store) processed (e.g., aggregated) information for a particular data field or record without having to store incremental data that is generated for that field or record. For example, hourly channel viewing information may be determined using aggregated data.

In one particular implementation, processing may be controlled by a central facility. For example, a central facility may command particular user equipment to process data to obtain aggregate information. The command may be sent by the central facility in a polling message sent to the user equipment. An application for processing the data may be resident at the user equipment or may be distributed over different sites (e.g., distributed over the user equipment and the central facility).

Screening data (e.g., step 804) and/or collecting data (e.g., step 603 of FIG. 8) may involve using particular memory addresses in user equipment to identify (implicitly identify) information that is to be communicated to a central facility. For example, particular data records may be selected implicitly by reference to or selected according to corresponding memory blocks in user equipment (e.g., memory blocks in a data collection device). This selection technique may be implemented without using explicit reference to a particular data record or data field that is stored in the user equipment. For example, a central facility may poll some user equipment to report data back by requesting information that is identified by the specific blocks of memory in the user equipment. The central facility may identify the bounds of memory (e.g., Hex002CB01A to HEX003A000) that contain the information that the central facility needs. This screening and/or data communication technique may be performed without having to explicitly identify data record types or attributes thereof. Software version information (e.g., the name or the version number) and/or user equipment identification information may be used by the central facility to determine which memory sections at user equipment (e.g., a particular type of user equipment) correspond to which data records or fields.

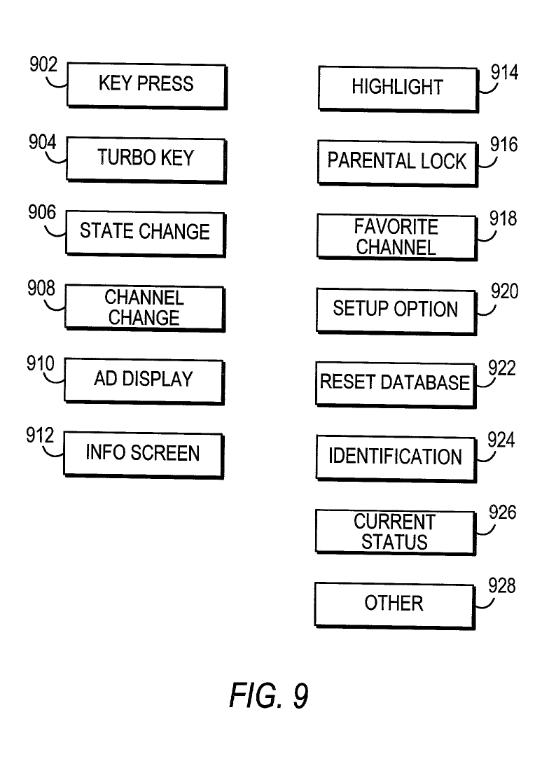

FIG. 9 shows illustrative data collection classes for generating interface data. Data or data records for a group (e.g., all) of the different classes may form an activity log. Data for each class may be generated in a format (e.g., a data record) from which that particular class or an activity under that particular class may be identified. Data may be generated as data records that can be imported into conventional database applications. For example, for each particular act that occurs a data record may be generated that has a number of predetermined fields that are separated by a marker such as a semicolon. The data may be in raw format, for example, by simply containing a string of alphanumerical characters that cannot be readily understood upon user review (such as review using a text editor). Data records (e.g., every data record) may (when appropriate) include data that is representative of when the event occurred, data that is representative of the duration of the event, a checksum, data identifying the classification for a data record, an identifier for each data record, etc. In one technique, a leading character may be used for each data record to identify classification for that record. The above mentioned data fields apply to the specific classifications mentioned below, but are not mentioned again to prevent repetition.

As shown in FIG. 9, one interface classification may be key press entry classification 902. Data may be generated for this classification when key entry on a user input device is recognized by the interactive television application. Data that is generated for key press entry 902 may include an identifier for identifying which key was pressed.

For turbo key classification 904, data may be generated when the user holds a key on a user input device long enough to generate a new action. This data may include a data record that includes a field for identifying the key that was pressed.

For state change classification 906, data may be generated when the guide changes states. For example, a data record may be generated when a parent control state is entered (e.g., a parental control display screen is displayed when a parental control option is selected from a main menu mode, e.g., from a main menu display screen). A table of different states is discussed below.

For channel change classification 908, data may be generated when a new channel or a new program is tuned. The data may include a data record that includes a field for the channel identifier and a field for the program identifier.

For ad display classification 910, data may be generated when the guide displays a display screen that includes one or more advertisements. A data record may be generated for classification 910 that includes a data record having data fields for identifying the number of advertisements or the graphic type of advertisements (e.g., flip ads) and includes data fields for identifying which advertisements were displayed.

For information screen classification 912, data may be generated when the guide displays an information display screen. Data that may be generated for classification 912 may include a data record that includes data fields for identifying the type of information display screen that was displayed (e.g., an advertisement information display screen, a program information display screen, a channel information display screen, etc.) and for identifying the focus of the information (e.g., the channel, the program, the advertisement, etc.).

For highlight classification 914, data may be generated when a program or other selection is highlighted on practically any display of the program guide. A highlight window may be a window that can be moved under user control in program guide displays that are presented to users. Data may be generated to track the movement of the highlight window. Data may be generated for classification 914 that includes a data record that identifies the programs or other items that have been highlighted using the highlight window. To select an item, user may press a data entry key when the highlight window is positioned on that item.

For parental lock classification 916, data may be generated when a user interacts with parental control features. Data generated for classification 916 may include a data record that includes data fields for identifying whether a lock has been set or removed, identifying the type of lock that is set or removed (e.g., movie rating, program, television rating, channel, etc.), and the identity of what is being locked or unlocked (e.g., the channel, the rating, etc.).

For favorite channel classification 918, data may be generated when the user sets or clears favorite channels. Data generated for classification 918 may include a data record including fields for identifying whether a favorite channel was set or cleared and for identifying the channel that is involved.

For setup classification 920, data may be generated when a user sets or clears setup options. A table of setup options is discussed below. Data may be generated for classification 920 that identifies the option and the change in setting that has occurred.

For reset database classification 922, data may be generated when the program guide resets or purges the program guide database. Data that is generated for classification 922 may identify the reason for resetting or purging the database.

For identification classification 924, data may be generated (e.g., generated periodically) that identifies the user equipment. Data that may be generated for classification 924 may include a data record that includes fields for identifying software versions, identifying hardware type, identifying the address of the hardware (e.g., address of a set-top box, television, VCR, etc.). The address may be used in the polling scheme discussed above to differentiate between different user equipment that have been deployed.

For current status classification 926, data may be generated periodically or at different intervals to indicate the current status of the interface. Data records may be generated using data record structures/coding used for the other classifications (e.g., channel change classification 908, parental lock classification 916, etc.) to indicate the current state of the interface when a discrete change at the interface has not occurred for some time. This data record may serve as a confirmation of a previously generated data record. Other classification 928 may cover other data that may have been produced. For classification 928, data may be generated for cumulative information such as for the cumulative amount of time programs in a particular genre was watched, for the cumulative amount of time a particular channel was watched, for the total amount of watching television viewing time, for the cumulative guide usage time, for the cumulative amount of time program listings were used, for the cumulative amount of time information display screens were used, for the cumulative amount of time since the hardware (e.g., the user equipment on which the interactive television application was implemented) was powered up, etc. From duration information, rate of usage over a period of time may be determined. For example, data may be produced for the frequency at which input device keys were pressed, the frequency at which a record button or option was used, the frequency at which a watch/tune button or option was used, the frequency at which a search button or option was used (e.g., used in general, used for a particular category, etc.), the frequency at which setup options were used, the frequency at which particular buttons were used to go directly to a particular channel or display screen, the frequency at which a guide button or option was used to go to an initial navigation screen of the interactive television application, the frequency at which displayed advertisements were selected. Other data that may be generated may include data on when, where, the display duration, and the screen location of a displayed advertisement, data on which portions of a television program were viewed, data on how long information display screens were viewed, etc. Data records (e.g., data records under other classification 928) may be defined to include data fields that are derived from data generated from interface activity or is the result of combining (e.g., aggregating) data generated from interface activity.

Data related to specific display levels of an advertisement may also generated and stored. For example, data may be generated for an advertisement when an initial display region for a particular advertisement is displayed in a program guide display screen. Data may also be generated for a further display region that is displayed for that same advertisement when a user selects the initial display region to obtain additional information (e.g., data is generated for the further graphics that are displayed when an initial display graphic for an advertisement is selected). A data record may identify that an advertisement was selected and may include fields identifying duration of display, further user activity, etc. If desired, a pulse data record may be periodically generated to indicate current operability of an interactive television application. If desired some or all of the data described herein may be generated or produced at a data collection device at a user's home. Other data and/or other techniques for generating data may also be used.

Memory used in the normal operation of an interactive television application may be copied and used to recreate a history of user activity (e.g., mirror the activity). Blocks of memory may be transmitted to a central facility for analysis. Information about the software version of the interactive television application, the identity of the application, and the hardware on which the application was implemented may also be provided to the central facility. The blocks that are to be transmitted may be identified by the local hardware or by the central facility. One advantage of providing information in a raw data format (e.g., using data records) is that the raw data provides flexibility for applying the data to a wide range of research purposes.

For state change classification 906, discussed above, there may be a large number of different states that may be tracked. Table 1 below illustratively shows a list of different guide states and an illustrative data value that may be generated to identify each state.

TABLE 1

| Value | State |
|---|---|
| 1 | Context Sensitive Help |
| 2 | Feature Unavailable |
| 3 | Guide Disconnect (e.g., guide unavailable) |
| 4 | Standby (e.g., guide on standby) |
| 5 | Idle |
| 6 | Turning Error |
| 7 | Flip |
| 8 | Browse |
| 9 | Main Menu |
| 10 | Listings By Time |
| 11 | Listings By Channel |
| 12 | Movies (e.g., movie listings) |
| 13 | Sports (e.g., sports listings) |
| 14 | Children (e.g., Children program listings) |
| 15 | Search |
| 16 | PPV By Time (e.g., pay-per-view listings by |
| | time) |
| 17 | PPV By Title |
| 18 | Subscription Service Listings |
| 19 | Watch Previews |
| 20 | Message Center |
| 21 | Message Screen |
| 22 | No Messages Notice |
| 23 | No Parental Control Code Overlay |
| 24 | Confirm New Code Overlay |
| 25 | Enter parental Control Code Overlay |
| 26 | Re-Enter Code Overlay |
| 27 | Code Incorrect Notice |
| 28 | Parental Control Criteria Screen |
| 29 | Master Locks Screen |
| 30 | Clear All Locks Confirmation Overlay |
| 31 | Parental Control By Example Overlay |
| 32 | Maximum Title Locks Set Notice |
| 33 | Restricted Overlay |
| 34 | Reactivate Locks Overlay |
| 35 | Favorites Screen |
| 36 | Clear All Favorites Screen |
| 37 | Currently Off Air Notice |
| 38 | No Favorite Channels Currently Set Notice |
| 39 | Setup Menu Screen |
| 40 | Guide Setup Screen |
| 41 | About Us Screen |
| 42 | Parental Control Setup Screen |
| 43 | Cable Box Setup Screen |
| 44 | Configuration Review Screen |
| 45 | First Hidden Guide Stats Screen |
| 46 | Audio Setup Screen |
| 47 | Screen Position Adjust Screen |
| 48 | Language Setup Screen |
| 49 | Change Language Confirmation Screen |
| 50 | Channel Info Screen |
| 51 | Program Info Screen |
| 52 | Start Times Screen |
| 53 | PPV Info Screen |
| 54 | PPV Billboard Screen |
| 55 | PPV Confirmation with Purchase Code Screen |
| 56 | PPV Confirmation without Purchase Code Screen |
| 57 | Time Block Package Confirmation with Purchase |
| | Code Screen |
| 58 | Time Block Package Confirmation without |
| | Purchase Code Screen |
| 59 | Preview Overlay |
| 60 | PPV Phone Order Overlay |
| 61 | PPV and Package Cancel Overlay |
| 62 | PPV Conflict Overlay |
| 63 | PPV In-Progress Overlay |
| 64 | Out of Credit Notice |
| 65 | Thank You for Your Order Notice |
| 66 | Unable to Complete Order Notice |
| 67 | Maximum Number of PPV Orders Notice |
| 68 | Your Order Has Been Canceled Notice |
| 69 | Subscription Service Billboard Screen |
| 70 | Subscription Service Phone Order Overlay |
| 71 | Set Reminder Screen |
| 72 | Cancel Reminder Screen |
| 73 | Maximum Reminders Set Notice |
| 74 | Reminder List Overlay |
| 75 | PPV Program Starting Overlay |
| 76 | PPV Program Missed Overlay |
| 77 | No Other Showings Available Notice |
| 78 | Digital Music Flip |
| 79 | Digital Music Title/Track/Artist Info Screen |
| 80 | Billboard with Promotion Barker Text |
| 81 | Barker Text Over Video |
| 82 | Weather |
| 83 | RF Bypass |
| 84 | Time Block Package Info |
| 85 | Season Ticket Package Info |
| | Season Ticket Set Reminder |
| 87 | Season Ticket Cancel Reminder |
| 88 | Season Ticket Phone Order Overlay |

| Value | State |
|---|---|
| 25 | Enter parental Control Code Overlay |
| 26 | Re-Enter Code Overlay |
| 27 | Code Incorrect Notice |
| 28 | Parental Control Criteria Screen |
| 29 | Master Locks Screen |
| 30 | Clear All Locks Confirmation Overlay |
| 31 | Parental Control By Example Overlay |
| 32 | Maximum Title Locks Set Notice |
| 33 | Restricted Overlay |
| 34 | Reactivate Locks Overlay |
| 35 | Favorites Screen |
| 36 | Clear All Favorites Screen |
| 37 | Currently Off Air Notice |
| 38 | No Favorite Channels Currently Set Notice |
| 39 | Setup Menu Screen |
| 40 | Guide Setup Screen |
| 41 | About Us Screen |
| 42 | Parental Control Setup Screen |
| 43 | Cable Box Setup Screen |
| 44 | Configuration Review Screen |
| 45 | First Hidden Guide Stats Screen |
| 46 | Audio Setup Screen |
| 47 | Screen Position Adjust Screen |
| 48 | Language Setup Screen |
| 49 | Change Language Confirmation Screen |
| 50 | Channel Info Screen |
| 51 | Program Info Screen |
| 52 | Start Times Screen |
| 53 | PPV Info Screen |
| 54 | PPV Billboard Screen |
| 55 | PPV Confirmation with Purchase Code Screen |
| 56 | PPV Confirmation without Purchase Code Screen |
| 57 | Time Block Package Confirmation with Purchase Code Screen |
| 58 | Time Block Package Confirmation without Purchase Code Screen |
| 59 | Preview Overlay |
| 60 | PPV Phone Order Overlay |
| 61 | PPV and Package Cancel Overlay |
| 62 | PPV Conflict Overlay |
| 63 | PPV In-Progress Overlay |
| 64 | Out of Credit Notice |
| 65 | Thank You for Your Order Notice |
| 66 | Unable to Complete Order Notice |
| 67 | Maximum Number of PPV Orders Notice |
| 68 | Your Order Has Been Canceled Notice |
| 69 | Subscription Service Billboard Screen |
| 70 | Subscription Service Phone Order Overlay |
| 71 | Set Reminder Screen |
| 72 | Cancel Reminder Screen |
| 73 | Maximum Reminders Set Notice |
| 74 | Reminder List Overlay |
| 75 | PPV Program Starting Overlay |
| 76 | PPV Program Missed Overlay |
| 77 | No Other Showings Available Notice |
| 78 | Digital Music Flip |
| 79 | Digital Music Title/Track/Artist Info Screen |
| 80 | Billboard with Promotion Barker Text |
| 81 | Barker Text Over Video |
| 82 | Weather |
| 83 | RF Bypass |
| 84 | Time Block Package Info |
| 85 | Season Ticket Package Info Season Ticket Set Reminder |
| 87 | Season Ticket Cancel Reminder |
| 88 | Season Ticket Phone Order Overlay |

Table 2, below lists illustrative setup options and illustrative identification code for the setup options for use with setup option classification 920.

TABLE 2

| Code | Option | Code | Value |
|---|---|---|---|
| 1 | Flip Position | 0 | Bottom |
| | | 1 | Top |
| 2 | Flip Timeout | 3-15 | |
| 3 | Auto-Tune | 0 | No |
| | | 1 | Yes |
| 4 | Message Envelope | 0 | Off |
| | | 1 | On |
| 5 | Reminder Notice | 1-15 | |
| 6 | Parental Code | 0 | Any value |
| | | | (actual value |
| | | | not logged) |
| 7 | Purchase Code | 0 | Any value |
| | | | (actual value |
| | | | not logged) |
| 8 | Power Loss Lock | 0 | No |
| | | 1 | Yes |
| 9 | Time Display | 0 | Off |
| | | 1 | On |
| 10 | AC Output | 0 | Unswitched |
| | | 1 | Switched |
| 11 | RF Bypass | 0 | Off |
| | | 1 | On |
| 12 | Volume | 0-n | Actual Value |
| 13 | Mute | 0 | Off |
| | | 1 | Muted |
| 14 | Audio Output | 0 | TV |
| | | 1 | Stereo |
| | | 2 | Advanced |
| 15 | Stereo Output | 0 | Mono |
| | | 1 | Stereo |
| | | 2 | Matrix Stereo |
| 16 | Compression | 0 | None |
| | | 1 | Light |
| | | 2 | Heavy |
| 17 | Horizontal | +/− actual | |
| | Screen Offset | pixel offset | |
| 18 | Vertical Screen | +/− actual | |
| | Offset | pixel offset | |
| 19 | Language | 0 | U.S. English |
| | | 1 | Canadian |
| | | | English |
| | | 2 | French |
| | | 3 | Spanish |
| 20 | Adult Titles | 0 | Hide |
| | | 1 | Show |
| 21 | Bypass Locks | 0 | No |
| | | 1 | Yes |

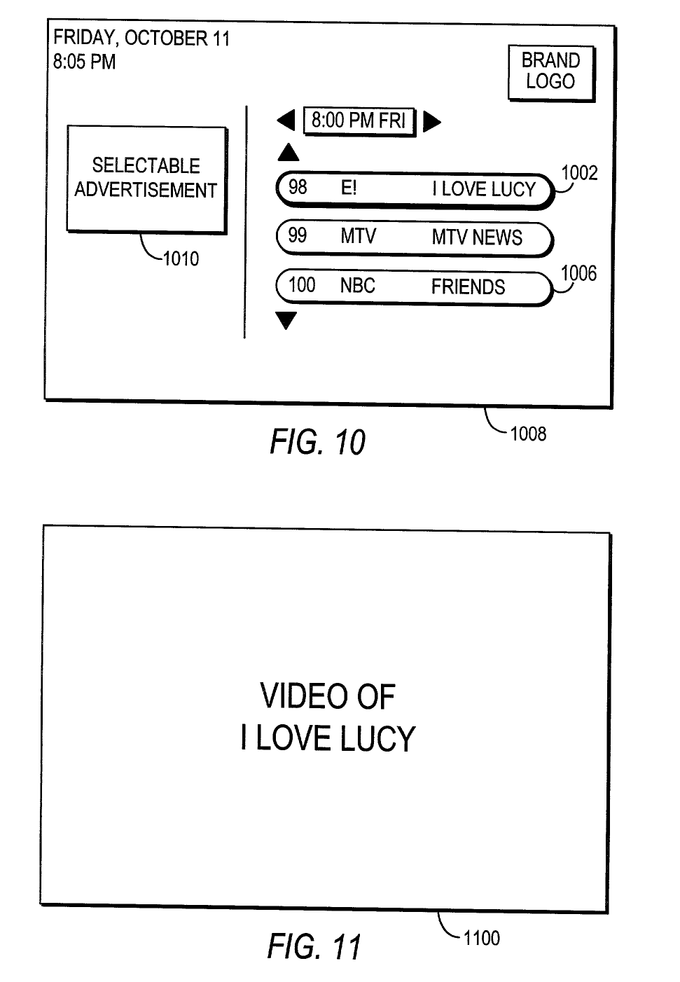

FIGS. 10-13 are presented illustratively to provide examples of discrete acts in a user application interface for which data may be generated for data collection.

FIG. 10 shows illustrative program listings for display screen 1008 that may have been displayed by an interactive television program guide. Data that may have been generated when display screen 1008 was displayed may, for example, include a data record for a key press that may have caused screen 1008 to be displayed, include a data record for the guide state (i.e., listings by time state), include a data record for advertisements 1010, and include a data record for highlighted listing 1002. A user may browse through listings by moving a highlight window using navigation keys of remote control 210 of FIG. 2. For each highlighted listing or key entry, appropriate data records may be generated and collected. After browsing through various channels, the user may decide to select channel 98 to watch I LOVE LUCY by pressing a data entry key (e.g., an “OK” key, an “enter” key, etc.) when listing 1006 is highlighted. A data record for the key press and another data record identifying the channel change and/or identifying the new program may be generated and stored.

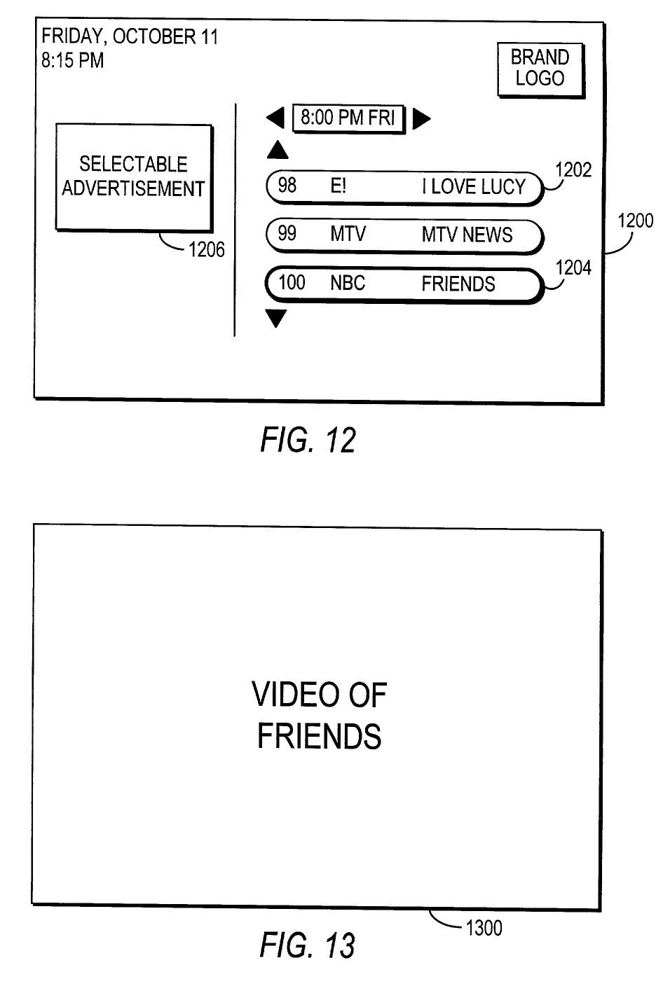

While watching I LOVE LUCY in screen 1100 of FIG. 11, the user may decide to change the program. A user may press a listings button of a remote control (for which one or more data records may be generated) to allow the user to view a list of programs. Display screen 1200 of FIG. 12 may be displayed presenting listings to the user. Data records similar to those described in connection with FIG. 10 are generated for the actions described in connection with FIG. 12. The user may select channel 100 (FRIENDS) by positioning a highlight window on listing 1204. Data may be generated identifying the portion of I LOVE LUCY that was watched. Video of FRIENDS on channel 100 may be displayed in screen 1300 of FIG. 13 and appropriate data for the channel change may be generated.

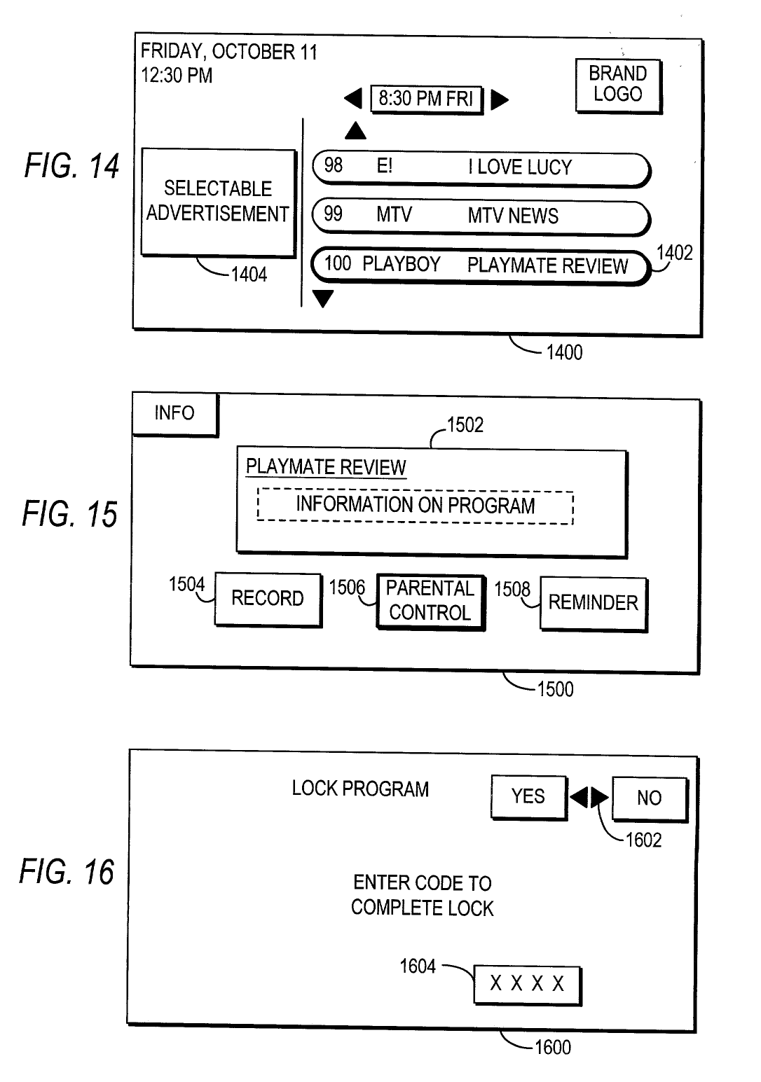

FIGS. 14-16 show further actions occurring in an interface between a user and an application that can be logged. FIG. 14 shows a listings display screen 1400 that may be displayed when a user selects a listings button of a remote control. Data records may be generated for the user pressing the listings button, for the guide entering a listings state, for advertisement 1404 that is displayed, and for the highlight window being on Playboy Channel listing 1404. In some guide embodiments, the selection of a listing will cause an information display screen to be displayed. Information display screen 1500 of FIG. 15 may be displayed when a user selects Playboy channel listing 1402 of FIG. 14. Data records may be generated for the change in display screens, for the change in guide states, and for the input device key that was pressed to access display screen 1500. Display screen 1500 may include information region 1502, record option 1504, parental control option 1506, and reminder option 1506. Examples of program guide systems and methods having information display screens are illustratively shown in U.S. patent application Ser. No. 09/356,268, which is hereby incorporated herein in its entirety. A user may move a highlight window within display screen 1500 (for which activity data will be generated) to select parental control option 1506. Illustrative parental control display screen 1600 may be displayed when the user selects parental control option 1506 of FIG. 15. Data records may be generated identifying that the parental control option was selected and identifying the change to the parental control state. Display screen 1600 may include option 1602 for selecting to set or remove a lock and code entry section 1604 for accepting parental control codes. Data may be generated for activity in display screen 1600 and for the user setting or removing a lock for the program. These interface activity are presented for illustrative purpose. Other interface activity may also be involved.

Thus, systems and methods for data collection and supporting research features for interactive applications may be provided.

It will be understood that the foregoing is only illustrative of the principles of the invention and that various modifications can be made by those skilled in the art without departing from the scope and spirit of the invention, which is limited only by the claims that follow.

What is claimed is:

1. A method comprising:
implementing an interactive television application using user equipment to provide interactive services to a user; and
generating an individual data record for each one of a series of discrete acts that occurred to interface the user and-the interactive television application.

2. The method of claim 1 further comprising implementing a data collection application to generate the data records.

3. The method of claim 1 further comprising providing the user equipment to include a set-top box.

4. The method of claim 1 further comprising:
implementing a data collection application to generate the data records on a plurality of user equipment in different households; and
selectively enabling a subset of the data collection applications.

5. The method of claim 1 further comprising sending the individual data records to a central facility.

6. The method of claim 1 further comprising screening the generated data records to filter out some of the records.

7. The method of claim 1 further comprising processing the individual data records to capture information from the data records.

8. The method of claim 1 wherein the generating comprises:
generating the data records to include one set of data records for identifying parameters for a user profile; and
generating the data records to also include another set of data records.

9. The method of claim 1 wherein the generating comprises:
generating the data records to include one set of data records for determining where to place interactive advertisements; and
generating the data records to also include another set of data records.

10. The method of claim 1 wherein the data records are in a format that is compatible with conventional database applications.

11. The method of claim 1 wherein the data records are generated for discrete acts that mark changes in an application flow of the interactive television application.

12. The method of claim 1 wherein the interactive television application is an interactive television program guide application.

13. The method of claim 1 further comprising:
implementing a storage device that stores the data records; and
providing a conversion device for converting signals carrying the data records between the user equipment and the storage device.

14. The method of claim 1 further comprising generating a data field in the data records for a time at which a particular act occurred.

15. The method of claim 1 further comprising generating a user input data record when the user presses a key on a user input device.

16. The method of claim 1 further comprising generating a turbo key data record when the user holds a key on a user input device to repeat the key entry.

17. The method of claim 1 further comprising generating a state change data record when the interactive television application changes states.

18. The method of claim 1 further comprising generating a channel change data record when the user changes channels.

19. The method of claim 1 further comprising generating an ad display data record when an advertisement is displayed by the interactive television application.

20. The method of claim 1 further comprising generating an information display data record when an information display screen is displayed.

21. The method of claim 1 further comprising generating a highlight data record when a highlight window is positioned on an item in a display screen.

22. The method of claim 1 further comprising generating a parental lock data record when a parental control feature is selected.

23. The method of claim 1 further comprising generating a favorite channel data record when a favorite channel option is selected.

24. The method of claim 1 further comprising generating a setup option data record when a user changes setup options.

25. The method of claim 1 further comprising generating a reset database data record when a database of the interactive television application is reset.

26. The method of claim 1 further comprising generating an identification data record to identify a software version of the interactive television application.

27. The method of claim 1 further comprising generating a current status data record to identify a current status of the interactive television application.

28. The method of claim 1 wherein the generating comprises generating the data records for automatic acts and for manual acts that occurred to interface the user and the interactive television application.

29. The method of claim 1 further comprising aggregating certain individual data records to form other data records.

30. The method of claim 1 further comprising processing the data records to reduce the amount of data.

31. The method of claim 1 further comprising screening the generated data records according to their position in memory to filter out some of the records.

32. A method comprising:
implementing an interactive television application using user equipment to provide interactive television services to a user;
collecting data representing actions taken by the user and the interactive television application; and
sending the collected data and a software version for the interactive television application to a central facility.

33. The method of claim 32 further comprising generating frequency data for interactions.

34. The method of claim 32 further comprising generating duration data for interactions.

35. The method of claim 32 further comprising polling the user equipment to send the collected data and the software version to the central facility.

36. The method of claim 32 further comprising screening the collected data.

37. The method of claim 32 further comprising processing the collected data.

38. The method of claim 32 wherein the user equipment comprises a television.

39. The method of claim 32 wherein the user equipment comprises a video recorder.

40. The method of claim 32 wherein the user equipment comprises a set-top box.

41. The method of claim 32 further comprising generating data on selections that the user makes through interactions.

42. The method of claim 32 wherein the collecting comprises collecting data on user input entries.

43. The method of claim 32 wherein the collecting comprises collecting data on information presented to the user by the interactive television application.

44. The method of claim 32 wherein the collecting comprises collecting data on activity occurring on the user equipment.

45. The method of claim 32 wherein the sending comprises sending the collected data based on their position in memory at the user equipment.

46. A system comprising:
means providing an interactive television application implemented using user equipment to provide interactive services to a user; and
means for generating an individual data record for each one of a series of discrete acts that occurred to interface the user and the interactive television application.

47. The system of claim 46 further comprising means for providing a data collection application implemented to generate the data records.

48. The system of claim 46 wherein the user equipment includes a set-top box.

49. The system of claim 46 further comprising:
means for implementing a data collection application to generate the data records on a plurality of user equipment in different households; and
means for selectively enabling a subset of the data collection applications.

50. The system of claim 46 further comprising means for sending the individual data records to a central facility.

51. The system of claim 46 further comprising means for screening the generated data records to filter out some of the records.

52. The system of claim 46 further comprising means for processing the individual data records to capture information from the data records.

53. The system of claim 46 wherein the means for generating comprises means for generating the data records to include one set of data records for identifying parameters for a user profile and for generating the data records to also include another set of data records.

54. The system of claim 46 wherein the means for generating comprises means for generating the data records to include one set of data records for determining where to place interactive advertisements and for generating the data records to also include another set of data records.

55. The system of claim 46 wherein the data records are in a format that is compatible with conventional database applications.

56. The system of claim 46 wherein the data records are generated for discrete acts that mark changes in an application flow of the interactive television application.

57. The system of claim 46 wherein the interactive television application is an interactive television program guide application.

58. The system of claim 46 further comprising:
a storage device that stores the data records; and
means for converting signals carrying the data records between the user equipment and the storage device.

59. The system of claim 46 further comprising means for generating a data field in the data records for a time at which a particular act occurred.

60. The system of claim 46 further comprising means for generating a user input data record when the user presses a key on a user input device.

61. The system of claim 46 further comprising means for generating a turbo key data record when the user holds a key on a user input device to repeat the key entry.

62. The system of claim 46 further comprising means for generating a state change data record when the interactive television application changes states.

63. The system of claim 46 further comprising means for generating a channel change data record when the user changes channels.

64. The system of claim 46 further comprising means for generating an ad display data record when an advertisement is displayed by the interactive television application.

65. The system of claim 46 further comprising means for generating an information display data record when an information display screen is displayed.

66. The system of claim 46 further comprising means for generating a highlight data record when a highlight window is positioned on an item in a display screen.

67. The system of claim 46 further comprising means for generating a parental lock data record when a parental control feature is selected.

68. The system of claim 46 further comprising means for generating a favorite channel data record when a favorite channel option is selected.

69. The system of claim 46 further comprising means for generating a setup option data record when a user changes setup options.

70. The system of claim 46 further comprising means for generating a reset database data record when a database of the interactive television application is reset.

71. The system of claim 46 further comprising means for generating an identification data record to identify a software version of the interactive television application.

72. The system of claim 46 further comprising means for generating a current status data record to identify a current status of the interactive television application.

73. The system of claim 46 wherein the means for generating comprises means for generating the data records for automatic acts and for manual acts that occurred to interface the user and the interactive television application.

74. The system of claim 46 further comprising means for aggregating certain individual data records to form other data records.

75. The system of claim 46 further comprising means for processing the data records to reduce the amount of data.

76. The system fo claim 46 further comprising means for screening the generated data records according to their position in memory to filter out some of the records.

77. A system comprising:
means for providing an interactive television application implemented using user equipment to provide interactive television services to a user;
means for collecting data representing actions taken by the user and the interactive television application; and
means for sending the collected data and a software version for the interactive television application to a central facility.

78. The system of claim 77 further comprising means for generating frequency data for interactions.

79. The system of claim 77 further comprising means for generating duration data for interactions.

80. The system of claim 77 further comprising means for polling the user equipment to send the collected data and the software version to the central facility.

81. The system of claim 77 further comprising means for screening the collected data.

82. The system of claim 77 further comprising means for processing the collected data.

83. The system of claim 77 wherein the user equipment comprises a television.

84. The system of claim 77 wherein the user equipment comprises a video recorder.

85. The system of claim 77 wherein the user equipment comprises a set-top box.

86. The system of claim 77 further comprising means for generating data on selections that the user makes through interactions.

87. The system of claim 77 wherein the means for collecting comprises means for collecting data on user input entries.

88. The system of claim 77 wherein the means for collecting comprises means for collecting data on information presented to the user by the interactive television application.

89. The system of claim 77 wherein the means for collecting comprises means for collecting data on activity occurring on the user equipment.

90. The system of claim 77 wherein the means for sending comprises means for sending the collected data based on their position in memory at the user equipment.

91. A system comprising:
user equipment that provides interactive services to a user using an interactive television application, and that generates an individual data record for each one of a series of discrete acts that occurred to interface the user and the interactive television application.

92. The system of claim 91 wherein the user equipment uses a data collection application to generate the data records.

93. The system of claim 91 wherein the user equipment includes a set-top box.

94. The system of claim 91 further comprising:
a plurality of the user equipment that each use a data collection application to generate the data records in different households; and
means for selectively enabling a subset of the data collection applications.

95. The system of claim 91 wherein the user equipment sends the individual data records to a central facility.

96. The system of claim 91 wherein the user equipment screens the generated data records to filter out some of the records.

97. The system of claim 91 wherein the user equipment processes the individual data records to capture information from the data records.

98. The system of claim 91 wherein the user equipment generates the data records to include one set of data records for identifying parameters for a user profile and the user equipment generates the data records to also include another set of data records.

99. The system of claim 91 wherein the user equipment generates the data records to include one set of data records for determining where to place interactive advertisements and the user equipment generates the data records to also include another set of data records.

100. The system of claim 91 wherein the data records are in a format that is compatible with conventional database applications.

101. The system of claim 91 wherein the data records are generated for discrete acts that mark changes in an application flow of the interactive television application.

102. The system of claim 91 wherein the interactive television application is an interactive television program guide application.

103. The system of claim 91 further comprising:
a storage device that stores the data records; and
a conversion device for converting signals carrying the data records between the user equipment and the storage device.

104. The system of claim 91 wherein the user equipment generates a data field in the data records for a time at which a particular act occurred.

105. The system of claim 91 wherein the user equipment generates a user input data record when the user presses a key on a user input device.

106. The system of claim 91 wherein the user equipment generates a turbo key data record when the user holds a key on a user input device to repeat the key entry.

107. The system of claim 91 wherein the user equipment generates a state change data record when the interactive television application changes states.

108. The system of claim 91 wherein the user equipment generates a channel change data record when the user changes channels.

109. The system of claim 91 wherein the user equipment generates an ad display data record when an advertisement is displayed by the interactive television application.

110. The system of claim 91 wherein the user equipment generates an information display data record when an information display screen is displayed.

111. The system of claim 91 wherein the user equipment generates a highlight data record when a highlight window is positioned on an item in a display screen.

112. The system of claim 91 wherein the user equipment generates a parental lock data record when a parental control feature is selected.

113. The system of claim 91 wherein the user equipment generates a favorite channel data record when a favorite channel option is selected.

114. The system of claim 91 wherein the user equipment generates a setup option data record when a user changes setup options.

115. The system of claim 91 wherein the user equipment generates a reset database data record when a database of the interactive television application is reset.

116. The system of claim 91 wherein the user equipment generates an identification data record to identify a software version of the interactive television application.

117. The system of claim 91 wherein the user equipment generates a current status data record to identify a current status of the interactive television application.

118. The system of claim 91 wherein the user equipment generates the data records for automatic acts and for manual acts that occurred to interface the user and the interactive television application.

119. The system of claim 91 wherein the user equipment aggregates certain individual data records to form other data records.

120. The system of claim 91 wherein the user equipment processes the data records to reduce the amount of data.

121. The system fo claim 91 wherein the user equipment screens the generated data records according to their position in memory to filter out some of the records.

122. A system comprising:
user equipment that provides interactive television services to a user using an interactive television application, that collects data representing actions taken by the user and the interactive television application, and sends the collected data and a software version for the interactive television application to a central facility.

123. The system of claim 122 wherein the user equipment generates frequency data for interactions.

124. The system of claim 122 wherein the user equipment generates duration data for interactions.

125. The system of claim 122 wherein the user equipment is configured to be polled by the central facility to send the collected data and the software version to the central facility.

126. The system of claim 122 wherein the user equipment screens the collected data.

127. The system of claim 122 wherein the user equipment processes the collected data.

128. The system of claim 122 wherein the user equipment comprises a television.

129. The system of claim 122 wherein the user equipment comprises a video recorder.

130. The system of claim 122 wherein the user equipment comprises a set-top box.

131. The system of claim 122 wherein the user equipment generates data on selections that the user makes through interactions.

132. The system of claim 122 wherein the user equipment collects data on user input entries.

133. The system of claim 122 wherein the user equipment collects data on information presented to the user by the interactive television application.

134. The system of claim 122 wherein the user equipment collects data on activity occurring on the user equipment using the interactive television application.

135. The system of claim 122 wherein the user equipment sends the collected data based on their position in memory at the user equipment.
